(19) United States
(12) Patent Application Publication
(10) Pub. No.: US 2020/0381135 A1
(43) Pub. Date: Dec. 3, 2020

(54) MICRO-FUSION-BASED ELECTRICITY GENERATING FARM

(71) Applicant: Jerome Drexler, Los Altos Hills, CA (US)

(72) Inventor: Jerome Drexler, Los Altos Hills, CA (US)

(21) Appl. No.: 16/423,445

(22) Filed: May 28, 2019

(51) Int. Cl. G21H 7/00; G21B 1/19; G21B 1/15

(52) U.S. Cl. CPC G21H 7/00; G21B 1/15; G21B 1/19

(57) ABSTRACT

An electricity generating farm includes an electrical grid with a network of conductive lines and switches, and a plurality of micro-fusion-driven turbine generator units selectively connected to the grid. Each generator unit includes a source of deuterium-containing particle fuel material that can be supplied as a dispersed cloud in a columnar reaction volume. Ambient cosmic rays and muons entering the reaction volume interact with the dispersed fuel material to generate energetic reaction products that drive turbines coupled to electrical generators.

### TECHNICAL FIELD

The present invention relates to electrical generating systems, and to the inducement and production of controlled nuclear fusion by particle-target and muon-catalyzed micro-fusion for electric power generation in the presence of ambient cosmic rays and muons. These may be especially useful in providing sufficient electrical energy for operations in space, such as on the surface of the Moon, Mars, or other lunar or planetary surfaces with little or no magnetic field and/or atmosphere, but may be developed and tested at suitable locations on Earth where ambient muon and cosmic flux is especially high.

### BACKGROUND ART

Muon-catalyzed fusion was observed by chance in late 1956 by Luis Alvarez and colleagues during evaluation of liquid-hydrogen bubble chamber images as part of accelerator-based particle decay studies. These were rare proton-deuteron fusion events that only occurred because of the natural presence of a tiny amount of deuterium (about one part per 6400) in the liquid hydrogen. It was quickly recognized that fusion many orders of magnitude larger would occur with either pure deuterium or a deuterium-tritium mixture. However, John D. Jackson (Lawrence Berkeley Laboratory and Prof. Emeritus of Physics, Univ. of California, Berkeley) correctly noted that for useful power production there would need to be an energetically cheap way of producing muons. The energy expense of generating muons artificially in particle accelerators combined with their short lifetimes has limited its viability as an Earth-based fusion source, since it falls short of break-even potential.

Another controlled fusion technique is particle-target fusion which comes from accelerating a particle to sufficient energy to overcome the Coulomb barrier and interact with target nuclei. To date, proposals in this area depend upon using some kind of particle accelerator. Although some fusion events can be observed with as little as 10 KeV acceleration, fusion cross-sections are sufficiently low that accelerator-based particle-target fusion are inefficient and fall short of break-even potential.

It is known that cosmic rays are abundant in interplanetary space. Cosmic rays are mainly high-energy protons (with some high-energy helium nuclei as well) with kinetic energies in excess of 300 MeV. Most cosmic rays have GeV energy levels, although some extremely energetic ones can exceed 10¹⁸ eV. FIG. 7 shows cosmic ray flux distribution at the Earth's surface after significant absorption by Earth's atmosphere. In near-Earth space, the alpha magnetic spectrometer (AMS-02) instrument aboard the International Space Station since 2011 has recorded an average of 45 million fast cosmic ray particles daily (approx. 500 per second within that instrument's effective acceptance area and measurement energy range). The overall flux of galactic cosmic ray protons (above Earth's atmosphere) can range from a minimum of 1200 m⁻²s⁻¹sr⁻¹ to as much as twice that amount. (The flux of galactic cosmic rays entering our solar system, while generally steady, has been observed to vary by a factor of about 2 over an 11-year cycle according to the magnetic strength of the heliosphere.) In regions that are outside of Earth's protective magnetic field (e.g. in interplanetary space), the cosmic ray flux has been estimated to be several orders of magnitude greater. As measured by the Martian Radiation Experiment (MARIE) aboard the Mars Odyssey spacecraft, average in-orbit cosmic ray doses were about 400-500 mSv per year, which is an order of magnitude higher than on Earth.

Cosmic rays are known to generate abundant muons from the decay of cosmic rays passing through Earth's atmosphere. Cosmic rays lose energy upon collisions with atmospheric dust, and to a lesser extent atoms or molecules, generating elementary particles, including pions and then muons, usually within a penetration distance of a few cm. Typically, hundreds of muons are generated per cosmic ray particle from successive collisions. Near sea level on Earth, the flux of muons generated by the cosmic rays' interaction by the atmosphere averages about 70 m⁻²s⁻¹sr⁻¹. The muon flux is even higher in the upper atmosphere. Measured muon flux levels on Earth reflect the fact that both Earth's atmosphere and geomagnetic field tend to deflect charged particles and shield our planet from cosmic radiation. The amount of shielding is somewhat lower, and thus the cosmic ray flux and muon generation are greater, at higher elevations and altitudes. Mars is a different story, having very little atmosphere (only 0.6% of Earth's pressure) and no magnetic field, so that muon generation at Mars' surface is expected to be very much higher than on Earth's surface. Planetary moons, such as' Earth's Moon, or Phobos and Deimos around Mars, would experience similarly high levels of cosmic ray flux.

The United States has committed NASA to a long-term goal of human spaceflight and exploration beyond low-earth orbit, including crewed missions toward eventually achieving the extension of human presence throughout the solar system and potential human habitation on another celestial body (e.g., the Moon, Mars). An efficient power source is necessary for sustaining space-based operations, including running the equipment. As part of any manned exploration and human habitation of Mars, some form of electricity generation will be needed beyond that available from solar cells in order to power the habitats, life support, and scientific equipment.

Sustained investments in fundamental research and early-stage innovation in technologies is required to meet these ambitious goals. Such research and development activity is expected to proceed in several general stages, beginning with an Earth-reliant stage with research and testing on Earth and in low-Earth-orbit (e.g. at the International Space Station), then in cis-lunar space and/or on the lunar surface, to test and validate complex operations and components before moving on to largely Earth-independent stages. Such a proving ground stage would field one or more electrical generation systems to undergo a series of shakedown tests to demonstrate their capabilities, select a final architecture, and make needed upgrades revealed by the shakedown tests. While systems already in development for the initial Earth-reliant missions largely make use of existing technologies, investment in the development of newer technologies will be needed to meet the longer-term deep space challenges. It may be found from the testing that at suitable locations on Earth itself, reliable electrical generation from a large-scale generating farm could become commercially feasible.

### SUMMARY DISCLOSURE

Accordingly, the present invention provides a micro-fusion electricity generating farm, comprising an electrical grid having a network of conductive lines and switches, and a plurality of micro-fusion-driven turbine generator units, each generator unit selectively connectable to a conductive line of the electrical grid via one of the switches. Each of these generator units may include a source of deuterium-containing micro-fusion particle fuel material, a columnar reaction volume arranged to receive ambient cosmic rays and muons at an upper end thereof, a flue coupled to the source and reaction volume for dispersing fuel material into the reaction volume, a set of helium-wind turbines arranged around the reaction volume, wherein cosmic rays and muons entering the open end of the columnar reaction volume interact with the dispersed fuel material to cause nuclear micro-fusion events, kinetic-energy-containing micro-fusion products driving the helium-wind turbines; and a set of electrical generators coupled to the respective helium-wind turbines to convert mechanical motion of the driven turbines into electricity. A specified number of the generator units may be connected at any given time to the conductive lines to deliver a specified amount of electrical power to the grid.

The present invention takes advantage of the abundance of cosmic rays and generated muons on a planet or moon, as well as in planetary or lunar orbit or interplanetary space, to catalyze fusion events. The cosmic rays and muons are available here for free and do not need to be generated artificially in an accelerator. Fusion material will interact with the flux of cosmic rays and muons such that some combination of particle-target fusion and/or muon-catalyzed fusion will take place. Thus, each electrical generating unit employs a muon-catalyzed controlled nuclear micro-fusion method to create a “wind” of large numbers of high-energy helium nuclei to drive a set of turbines. These “helium-wind” turbines are mechanically connected to a corresponding number of induction generators to produce electricity. Since the amount of energy needed is generally much less than the multi-kiloton yields of atomic weapons, “micro-fusion” is the term used here to refer to total fusion energy outputs of not more than 10 gigajoules per second (2.5 tons of TNT equivalent per second), to thereby exclude macro-fusion type explosions. Individual micro-fusion reaction units in an electricity farm might produce up to about 10 kilojoules per second output, depending upon the ambient flux levels.

A cloud of fusion material is suspended within a reaction chamber and is bombarded with incoming cosmic rays and muons arriving through the top of the chamber. For example, ports from a fuel supply in the main body may inject a deuterium-containing micro-fusion fuel material as a dispersed cloud into the chamber. The top of the reaction volume may be openable as needed to receive ambient cosmic rays and muons or closed when its power is not needed (or depending upon weather). Alternatively, reaction volume of each generator unit may have a dome covering over its upper end, the dome allowing passage of the ambient flux of cosmic rays therethrough to enter the reaction volume. Ambient cosmic rays and muons penetrate the upper dome into the chamber and interact with the fuel to produce energetic reaction products. This dome might be double-paned and include muon-generating material between the panes, collisions of cosmic rays with the muon generating material supplying muons to the particle fuel material in the reaction volume.

Turbines arranged around the reaction chamber can be driven by the energetic products, such as alpha particles, in order to create electricity. The turbines may be arranged circumferentially around sides of the columnar reaction volume, and even stacked vertically in multiple layers around the sides of the reaction volume. One or more fans could be provided in the reaction volume to maintain the dispersed fuel material in suspension within.

When being tested or used on Earth, the electricity generating farm with its electrical grid and turbine generator units may be located at an altitude greater than 2500 m where ambient muon flux is increased.

### BRIEF DESCRIPTION OF THE DRAWINGS

FIG. 1 is a schematic plan view of the layout of an electricity generating farm in accord with the present invention, with an electrical grid and a plurality of micro-fusion-driven turbine generator units.

FIG. 2 is a schematic plan view of a micro-fusion-driven turbine generator unit for an electrical farm in accord with the present invention.

FIG. 3 is a side plan view of an upper portion of a generator unit as in FIG. 2, equipped with an openable and closeable protective cover.

FIG. 4 is a side plan view of an upper portion of a generator unit as in FIG. 2, equipped with a dome cover that permits passage of ambient cosmic rays and/or muons.

FIG. 5 is a top plan view of the reaction volume of a turbine generator unit as in FIG. 2 showing turbines and generators arranged circumferentially around a reaction volume.

FIG. 6 is a side plan view of the reaction volume of a turbine generator unit as in FIG. 2, with turbines and generators in a vertically stacked arrangement around the sides of the reaction volume.

FIG. 7 is a graph of cosmic ray flux at the Earth surface versus cosmic ray energy, after very significant cosmic ray absorption by Earth's atmosphere has occurred.

### DETAILED DESCRIPTION

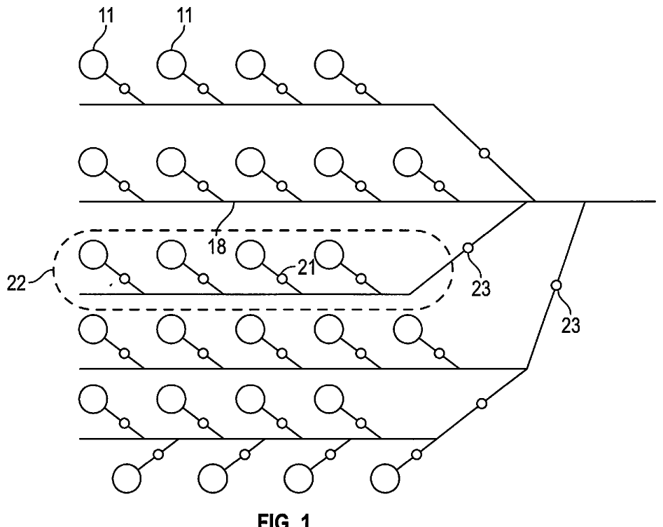

With reference to FIG. 1, an electricity farm in accord with the present invention includes a plurality of micro-fusion turbine generator units 11 distributed over a specified area where an ambient flux of cosmic rays and muons are present. Each generator unit 11 can produce a quantity of electric power, which can be connected via switches 21 to a network of conductive lines of an electrical grid 18. Likewise, groups 22 of units 11 may be selectively connected to the grid 18 via switches 23. How many generator units 11 are connected at any given time will depend on electricity demand and units 11 and groups 22 can be disconnected when not needed.

The micro-fusion electrical generator system works in the presence of an ambient flux of cosmic rays and/or muons which interact with the cloud and trigger the nuclear micro-fusion of the particle target material, either by particle-target micro-fusion or muon-catalyzed micro-fusion or both. The micro-fusion fuel releases as a cloud and can be solid Li⁶D in powder form, D-D or D-T inertial-confinement-fusion-type pellets, D₂O ice crystals, or droplets of (initially liquid) D₂. Each electrical generation unit employs a muon-catalyzed controlled nuclear micro-fusion method to create a “wind” of large numbers of high-energy helium nuclei to drive a set of turbines. These “helium-wind” turbines are mechanically connected to a corresponding number of induction generators to produce electricity. A cloud of micro-fusion target material is suspended within a reaction chamber and is bombarded with incoming cosmic rays and muons arriving through the top of the chamber. The micro-fusion target material will then interact with the ambient flux of cosmic rays and muons producing a combination of particle-target micro-fusion and/or muon-catalyzed micro-fusion, generating kinetic-energy-containing fusion products. Turbines arranged around the reaction chamber can be driven by the energetic products, such as alpha particles, in order to create electricity.

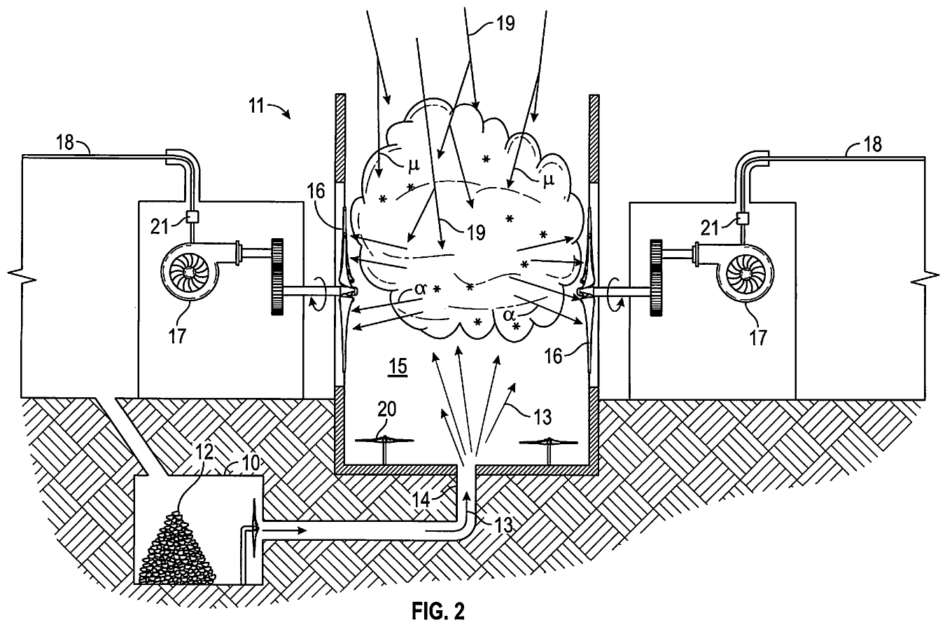

With reference to FIG. 2, the individual micro-fusion-driven turbine generator units 11 of the electrical farm, when in the presence of sufficient ambient flux of cosmic rays and muons, collectively provides electricity, for example, to one or more planetary or lunar colonies. Cosmic ray flux naturally present is used to power nuclear micro-fusion events (via particle-target micro-fusion and muon-catalyzed micro-fusion) that will generate electrical energy. Specifically, each generator unit 11 includes a source 10 of deuterium-containing micro-fusion particle fuel material 12. This material could be blown 13 through a flue 14, e.g. by means of a fan at the source 10 or by other means, depending on the form that the fuel material takes, and dispersed from the flue 14 into a reaction volume 15. The micro-fusion target fuel material 13 is dispersed in proximity to turbines 16 arranged around the reaction volume 15, and then exposed to ambient cosmic rays 19 and muons μ that enters the volume 15 and interacts with the dispersed fuel material 13 to cause nuclear micro-fusion events. A “wind” of micro-fusion products made up of energetic helium (alpha products) impinge upon and direct kinetic energy to the turbine blades 16 to turn the turbines and drive the associated generators 17 to produce electricity which, when connected to the electricity farm's grid 18, can then be supplied to a variety of habitats and equipment. A set of one or more fans 20 in the reaction volume 15 may help keep the fuel material in suspension near the turbines 16.

The reaction chamber need not be circular or radially symmetric, but could have an oval, elliptical, polygonal, or other odd shape. Cylindrical chambers and disc-shaped main bodies may be preferred for their compactness and economy of material, but other shapes are possible.

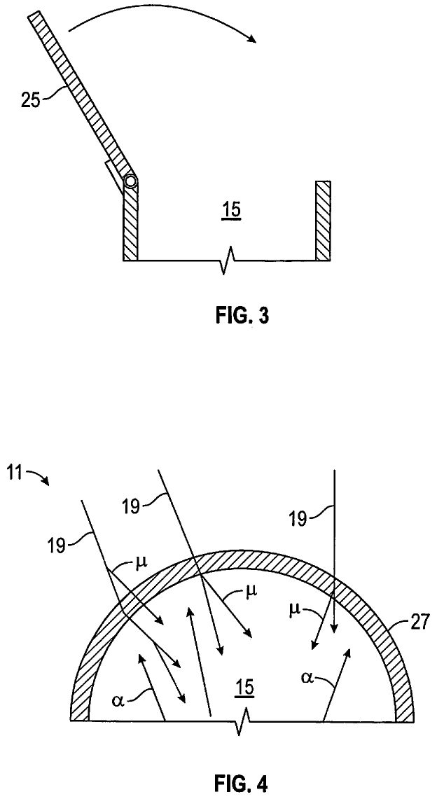

With reference to FIG. 3, the top of the reaction chamber 15 may include some form of protective cover 25 that can close when the unit is not needed or to keep out unwanted weather-related materials, such as wind-blown sand, dust, rain or snow. The protective cover 25 would be open when the unit is in operation. Alternatively, with reference to FIG. 4, each reaction chamber can have a dome 27 on top that is effectively transparent to cosmic rays 19, with their extremely high energies (>100 Mev) and penetrating power, but essentially opaque to the substantially lower energy (˜10 MeV) alpha particle reaction products that will thus be stopped by the dome 27. It is expected that the dome material can be the same as the external skin of the reaction chamber side walls, but possibly thinner. However, research and development efforts may optimize the choice of dome material and its thickness to achieve maximum cosmic ray penetration into the chamber, as well as to facilitate production of muons through interactions of those cosmic rays with the dome material. The dome might even be double-paned structure with internal wire mesh, fibers and or even fine particulates to enhance muon creation. (Such a double-paned structure may also facilitate the provision of a cooling water or gas flow between the panes.) Such the presence of muon generators as a permanent structure of the dome will lessen or even eliminate the need for having muon-generating particulate material within the fuel, thereby saving valuable fuel weight.

Additionally, the amount of curvature of the dome may be important to maximizing input of cosmic rays and muons into the chamber. The curvature of the “dome” may range from being completely flat to extending considerably upward above the top of the remainder of the reaction volume, perhaps as much as twice as high as its radius. The much larger surface area of a large curvature dome would facilitate cooling of the cover as it is bombarded with ambient cosmic rays penetrating from outside and with micro-fusion reaction products (energetic alpha particles a) from within. A larger curvature might also allow relief of mechanical stresses from any heating that does result.

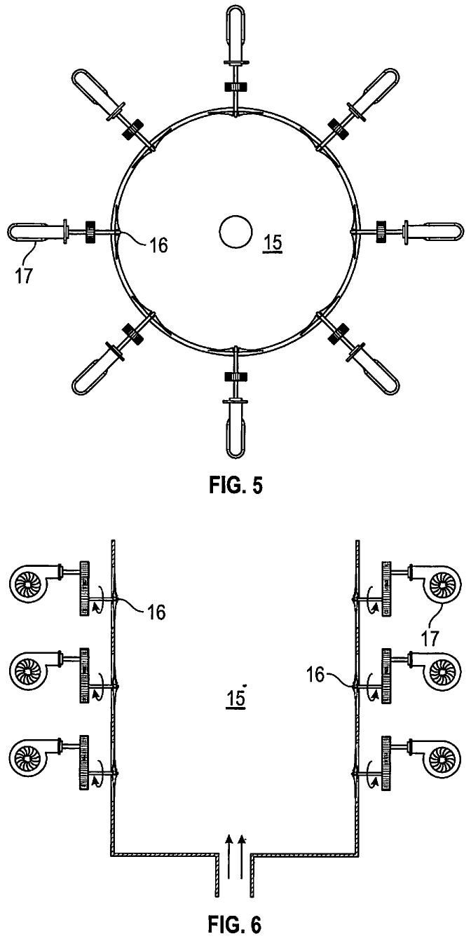

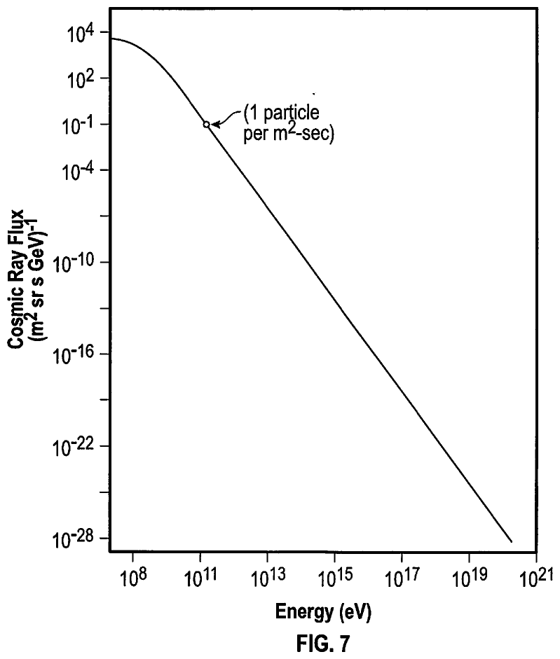

As seen in FIG. 5, the turbines 16 may be arranged around the circumference of the reaction volume 15, which can be cylindrical or any other equivalent columnar shape. While typically four in number, there can anywhere from as few as two up to 20 or more such turbines 16 (eight are seen here), depending on the space available, the size of the fusion reaction cloud, and the size and arrangement of the turbines themselves about the chamber 15. Alternatively, or in addition, as seen in FIG. 6, the turbines 16 may be arranged in multiple stacks along the length of the cylindrical reaction volume 15. Turbines are connected, e.g. through gearboxes, to corresponding induction generators 17. The generators 17 may be equal in number to the corresponding turbines 16 (1:1 correspondence), or multiple turbines may drive any given generator (n:1 correspondence).

On planetary or lunar surfaces, the chamber will be arranged with its cylindrical or columnar axis pointing in a generally vertical direction, since cosmic rays and generated muons will be arriving from above and the chamber should be pointed in a direction that will maximize receipt of cosmic rays onto the cloud of fusion target material within the chamber.

The deuterium “fuel” for a generator may be supplied in the form of clouds of solid lithium-6 deuteride powder, pellets or chips, or even frozen heavy water (D₂O) or liquid droplets of D₂, to a reaction chamber 15, where it is exposed to incoming cosmic rays 19 and muons μ, as seen in FIG. 2. One technique for creating the cloud of fusion target material is to shoot “fuel” packages as a series of small projectiles or pellets into the reaction chamber, which can then be dispersed as a localized cloud, much like fireworks. For this purpose, one or more “gun” tubes may be located below the chamber and loaded with the fuel packages for introduction into the chamber. Soon after each projectile has reached its desired dispersal location within the chamber, a small chemical explosion can be used to locally disperse the fusion material. Alternatively, packages may be “dropped” into the chamber from near the top via a slide dispenser or sprayed as fine droplets or powder through ports in the chamber's side walls. Stored fuel material will be shielded to reduce or eliminate premature fusion events until delivered and dispersed as a cloud in the reaction chamber.

For a typical cloud of Li⁶D in powder form it may be desired to disperse the material near the top of the chamber to allow maximum usage of the material while it settles toward the bottom of the chamber. It might also be advantageous in certain cases to provide one or more fans 20 at the bottom of the chamber 15 (seen in FIG. 2) to keep the cloud of target material suspended in the chamber as long as possible, but on the lunar surface there will be relatively low gravity, so that the micro-fusion fuel material settling too rapidly may not be a concern.

The dispersed cloud of target material will be exposed to both cosmic rays and to their generated muons. To assist in the formation of muons for muon-catalyzed fusion, especially when D₂O or D₂ is used, the target package may contain up to 20% by weight of added particles of fine sand or dust. (This is particularly important if one desires to create a similar fusion reaction on the Moon, which has no atmosphere.) As cosmic rays collide with both micro-fusion target material and dust, they form muons that are captured by the deuterium and that catalyze micro-fusion. Muonic deuterium, tritium or lithium-6 can come much closer to the nucleus of a similar neighboring atom with a probability of fusing deuterium nuclei, releasing energy. Once a muonic molecule is formed, fusion proceeds extremely rapidly (on the order of 10⁻¹⁰ sec). One cosmic ray particle can generate hundreds of muons, and each muon can typically catalyze about 100 fusion reactions before it decays (the exact number depending on the muon “sticking” cross-section to any helium fusion products).

Cosmic rays can themselves directly stimulate a fusion event by particle-target fusion, wherein the high energy cosmic ray particles (mostly protons, but also helium nuclei) bombard the cloud of target material. When bombarded directly with cosmic rays, the lithium may be transmuted into tritium which could form the basis for some D-T fusion reactions. Although D-D fusion reactions occur at a rate only 1% of D-T fusion, and produce only 20% of the energy by comparison, the freely available flux of cosmic rays and their generated muons should be sufficient to yield sufficient fusion energy output for practical use.

Besides D-D micro-fusion reactions, other types of micro-fusion reactions may also occur (e.g. D-T, using tritium generated by cosmic rays impacting the lithium-6; as well as Li⁶-D reactions from direct cosmic ray collisions). For this latter reaction, it should be noted that naturally occurring lithium can have an isotopic composition ranging anywhere from as little as 1.899% to about 7.794% Li⁶, with most samples falling around 7.4% to 7.6% Li⁶. Although LiD that has been made from natural lithium sources could also be used, fuel material that has been enriched with greater proportions of Li⁶ is preferable for achieving greater efficiency.

When used on Earth, some care will be needed when using some micro-fusion fuels. For example, lithium hydride (including Li⁶D) is known to be violently chemically reactive in the presence of water. While reactions with water are not a problem on the Moon or Mars, with any Earth applications the fuel material will need to be encapsulated to isolate it from water sources, including atmospheric vapor. A desiccant can also be used when storing the fuel material.

The rate of fuel usage will depend on the amount of electricity required, the amount of fusion obtained from the ambient cosmic ray and/or muon flux, the dispersal rate of the fuel cloud from the chamber and the efficiency of the transfer of the fusion products into turbine rotation. Assuming most of the energy can be captured, an estimated 10¹⁵ individual micro-fusion reactions (less than 1 μg of fuel consumed) per second would be required for 1 kW output. But as each cosmic ray can create hundreds of muons and each muon can catalyze 100 micro-fusion reactions, the available cosmic ray flux in interplanetary space is believed to be sufficient for this purpose following research, development, and engineering efforts.

The deuterium “fuel” may be supplied in the form of clouds of solid lithium-6 deuteride powder, pellets or chips, or even frozen heavy water (D₂O) or liquid droplets of D₂, to a reaction chamber 15, where it is exposed to incoming cosmic rays 19 and muons p. One technique for creating the cloud of fusion target material is to shoot “fuel” packages as a series of projectiles into the reaction chamber, which can then disperse the fusion material as a localized cloud, much like fireworks or artillery. For this purpose, one or more gun tubes may be located below the chamber and loaded with the packages for introduction into the chamber. Alternatively, packages may be dropped into the chamber from near the top via a slide dispenser. The fuel within the projectile packages can be solid Li⁶D in powder form, D-D or D-T inertial-confinement-fusion-type pellets, or D₂O ice crystals. Stored fuel will be shielded to reduce or eliminate premature fusion events until delivered and dispersed as a cloud in the reaction chamber.

Soon after the projectile has reached the desired dispersal location within the chamber, the package releases its target material. For example, a small chemical explosion can be used to locally disperse the fusion material.

For a typical cloud of Li⁶D in powder form it may be desired to disperse the material near the top of the chamber to allow maximum usage of the material while it settles toward the bottom of the chamber. It might be advantageous to provide one or more fans 20 at the bottom of the chamber 15 to keep the cloud of target material suspended in the chamber as long as possible.

The optimum concentration of the cloud of target material for the particle-target and muon-catalyzed fusion may be determined experimentally based on the particular abundance of cosmic rays with a view to maintaining a chain reaction of fusion events for producing adequate thrust against the turbine blades, while avoiding any possibility of runaway fusion.

Because the technology is still early in a developmental phase, testing of its concepts might be perfected at some locations on Earth before its deployment in outer space, even though the ambient flux of cosmic rays and muons may be much lower due to Earth's geomagnetic field and thick atmosphere. Both particle-target fusion and muon-catalyzed fusion, while recognized scientifically, are still experimentally immature technologies (since measurements have only been conducted to date on Earth using artificially accelerated particles and generated muons from particle accelerators), various embodiments of the present invention can have research utility to demonstrate feasibility in environments beyond Earth's protective atmosphere and/or geomagnetic field. First, testing with prototype electricity farms at convenient higher altitude Earth locations would allow designers to improve the proposed micro-fusion engines before their use on the Moon, and then Mars. A prototype farm may be placed at a convenient high-altitude location on Earth where muon flux is highest. (Both cosmic ray flux and muon generation are known to substantially increase with altitude.) Then, a satellite platform in Earth orbit (for example, on the International Space Station) to improve the efficiency of individual generator units. Still later, a lander on the surface of the Moon are both conveniently close to Earth to place experimental modules in order to determine optimum parameters (e.g. dimensions of the chamber, and cloud density for different fuel types) in order to adequately drive the turbines. For example, the actual number of micro-fusion reactions for various types of fusion fuel sources and target configurations, and the amount of electrical output that can be derived from such reactions, are still unknown and need to be fully quantified in order to improve the technology. The fusion-enhanced propulsion system requires strong cosmic ray flux to create sufficient nuclear micro-fusion, and therefore is best suited to operation in deep space environments.

What is claimed is:

1. A micro-fusion electricity generating farm, comprising:
an electrical grid having a network of conductive lines and switches;
a plurality of micro-fusion-driven turbine generator units, each generator unit selectively connectable to a conductive line of the electrical grid via one of the switches, each generator unit including:
a source of deuterium-containing micro-fusion particle fuel material;
a columnar reaction volume arranged to receive ambient cosmic rays and muons at an upper end thereof;
a flue coupled to the source and reaction volume for dispersing fuel material into the reaction volume;
a set of helium-wind turbines arranged around the reaction volume, wherein cosmic rays and muons entering the open end of the columnar reaction volume interact with the dispersed fuel material to cause nuclear micro-fusion events, kinetic-energy-containing micro-fusion products driving the helium-wind turbines; and
a set of electrical generators coupled to the respective helium-wind turbines to convert mechanical motion of the driven turbines into electricity.

2. The electricity generating farm as in claim 1, wherein a specified number of the generator units are connected at any given time to the conductive lines to deliver a specified amount of electrical power to the grid.

3. The electricity generating farm as in claim 1, wherein the columnar reaction volume of each generator unit is a cylinder with an openable cover at its upper end to receive the cosmic rays and muons.

4. The electricity generating farm as in claim 3, wherein the upper end of the reaction volume is closable.

5. The electricity generating farm as in claim 1, wherein the columnar reaction volume of each generator unit has a dome covering over its upper end, the dome allowing passage of the ambient flux of cosmic rays therethrough to enter the reaction volume.

6. The electricity generating farm as in claim 5, wherein the dome is double-paned and includes muon generating material between the panes, collisions of cosmic rays with the muon generating material supplying muons to the particle fuel material in the reaction volume.

7. The electricity generating farm as in claim 1, wherein the turbines are arranged circumferentially around sides of the columnar reaction volume.

8. The electricity generating farm as in claim 1, wherein turbines are stacked vertically in multiple layers around sides of the columnar reaction volume.

9. The electricity generating farm as in claim 1, wherein one or more fans are provided in the reaction volume to maintain the dispersed fuel material in suspension within the columnar reaction volume.

10. The electricity generating farm as in claim 1, wherein the deuterium-containing fuel material comprises Li⁶D.

11. The electricity generating farm as in claim 1, wherein the deuterium-containing fuel material comprises D₂O.

12. The electricity generating farm as in claim 1, wherein the deuterium-containing fuel material comprises D₂.

13. The electricity generating farm as in claim 1, wherein the deuterium-containing fuel material is in solid powder form.

14. The electricity generating farm as in claim 1, wherein the deuterium-containing fuel material is in pellet or chip form.

15. The electricity generating farm as in claim 1, wherein the deuterium-containing fuel material is in frozen form.

16. The electricity generating farm as in claim 1, wherein the deuterium-containing fuel material is in liquid droplet form.

17. The electricity generating farm as in claim 1, wherein the deuterium-containing fuel material also contains up to 20% by weight of added particles of fine sand or dust.

18. The electricity generating farm as in claim 1, wherein the electrical grid and turbine generator units are located at an altitude greater than 2500 m where ambient muon flux is maximized.
